(19) United States
(12) Patent Application Publication
(10) Pub. No.: US 2008/0037383 A1
(43) Pub. Date: Feb. 14, 2008

(54) Objective-lens driving apparatus and optical pickup and optical recording and reproducing apparatus for using same

(75) Inventor: Keiji Suzuki, Tokyo (JP)

Correspondence Address: WOLFF LAW OFFICE, PLLC, P.O. BOX 9855, CHAPEL HILL, NC, 27515-9855, US

(73) Assignee: TDK Corporation

(21) Appl. No.: 11/881,131

(22) Filed: Jul. 25, 2007

(30) Foreign Application Priority Data
Aug. 8, 2006 (JP) 2006-216099

(51) Int. Cl. G11B 7/00

(52) U.S. Cl. 369/44.14

(57) ABSTRACT

The objective-lens driving apparatus is provided with a yoke base, a lens holder provided on the yoke base, the objective lens provided to the center of the upper part of the lens holder, permanent magnets provided to both sides of the lens holder in the tangential direction, wires laid on both sides of the lens holder in the tracking direction, a wire base made of resin and provided in the area near the permanent magnet when viewed from the lens holder, and a yoke cover made of resin. The yoke cover serves as a stopper for limiting the movable range of the lens holder. A stopper part that extends toward the yoke cover in the wiring direction of the wires is provided to the lateral surface of the lens holder. An upper locking strip and a lower locking strip are provided to the lateral surface of the yoke cover.

### TECHNICAL FIELD

The present invention relates to an objective-lens driving apparatus, as well as to an optical pickup and an optical recording and reproducing apparatus that use the apparatus for driving an objective lens.

### BACKGROUND OF THE INVENTION

Mainstream objective-lens driving apparatuses are of a wire-support type wherein a lens holder on which an objective lens and a driving coil are mounted is elastically supported by a plurality of wires, and wherein a permanent magnet is positioned in the vicinity of the lens holder, electric current is supplied through the wires to the driving coil, and the state of the objective lens is controlled. This type of objective-lens driving apparatus is usually covered by an apertured cover on the upper surface of the objective lens. This cover is provided in order to prevent damage to the optical disk due collisions between the permanent magnet or yoke and the optical disk, to prevent deformations of the wires due to the fingers of the workers contacting the wires during manufacture, or to prevent reduction or deterioration of the damping material cushioning the wires due to touching. The cover described in, e.g., Japanese Laid-Open Patent Application No. H09-180223 is shaped so as to cover the upper surface, the lateral surface on the inner circumferential side, and the lateral surface on the outer circumferential side of the objective-lens driving apparatus.

The demand for faster data recording and reproducing has been increasing in recent years due to the increasing capacity of optical disks. The increased spindle-motor size accompanying the increasing speed of recording and reproducing is unavoidable, and the space occupied by spindle motors in the radial direction continues to expand. Problems have accordingly arisen in that the objective-lens driving apparatus cannot be moved to the innermost circumference of the optical disk when an optical pickup having the conventional structure described above is used without modification in situations in which the space occupied by the spindle motor is expanded. Problems have also arisen in that the movable range of the lens holder is limited when the lateral plate part on the inner circumferential side of the cover is bent into an arc shape in conformity with the shape of the outer circumference of the spindle motor in order to prevent collisions of the cover and the spindle motor.

### SUMMARY OF THE INVENTION

It is therefore an object of the present invention to provide a small-sized objective-lens driving apparatus that is capable of preventing the permanent magnet or the yoke from colliding with the optical disk; and to provide an optical pickup and an optical recording and reproducing apparatus in which this apparatus is used.

The above and other objects of the present invention can be accomplished by an objective-lens driving apparatus comprising a lens holder for holding an objective lens; a driving coil attached to the lens holder; a permanent magnet for producing a magnetic flux in the driving coil; a yoke base (base member) to which the permanent magnet is attached; a wire (supporting member) for elastically supporting the lens holder and for supplying electrical current to the driving coil; a wire base (fixation member) to which an end of the wire is fixed; and a yoke cover made of a resin and attached to the raised part of the yoke base, wherein an upper surface of the yoke cover is higher than the upper surface of the permanent magnet and the raised part of the yoke base.

According to the objective-lens driving apparatus of the present invention, instead of covering the entirety of the objective-lens driving apparatus using a cover, only the necessary portions; i.e., the permanent magnet and the raised part of the yoke base, are covered. Defects due to the absence of the cover can accordingly be avoided, and reductions in the overall size of the apparatus can be achieved. In other words, even if the objective-lens driving apparatus collides with the optical disk, the yoke cover and not the metal portions, i.e., the permanent magnet and the raised part of the yoke base, will collide with the optical disk, and therefore the impact on the disk surface can be largely alleviated.

The objective-lens driving apparatus of the present invention preferably further comprises a stopper part, which is provided to one of the lens holder and the yoke cover, is extended toward the other of the lens holder and the yoke cover, and is made to limit movable range of the lens holder in a tracking direction; and a locking strip, which is provided to the other of the lens holder and the yoke cover and that is made to limit at least movable range of the stopper part in a focusing direction. The yoke cover can thereby double as means for controlling the movable range of the objective lens, and a high-performance objective-lens driving apparatus having a small size can be implemented.

The yoke cover of the present invention preferably comprises a structure capable of being attached and detached from the raised part of the yoke base. In particular, the yoke cover preferably comprises a gap part having a width equal to a thickness of the raised part of the yoke base; and a structure in which the raised part is fit into the gap part. The yoke cover can thereby be reliably attached to the raised part of the yoke base using a simple structure. In particular, the yoke cover is temporarily fixed to the yoke base in a reliable manner, for which reason bonding and other operations are easily performed.

The above and other objects of the present invention can also be accomplished by an optical pickup comprising a laser light source; an objective lens for focusing a laser beam emitted from the laser light source onto a recording surface of an optical disk; a light detector for receiving light reflected from the optical disk; and the aforedescribed objective-lens driving apparatus for driving the objective lens.

The above and other objects of the present invention can also be accomplished by an optical recording and reproducing apparatus comprising a spindle mechanism for causing an optical disk to rotate; the aforedescribed optical pickup provided to be capable of moving freely on a radial direction of the optical disk; and a controller for controlling the optical pickup.

According to the present invention, a small-sized objective-lens driving apparatus can be provided in which the impact on an optical disk during collisions is alleviated by providing a resin-material cover to the permanent magnet, base, and other metal members; and an optical pickup and an optical recording and reproducing apparatus that use this apparatus can be provided.

### BRIEF DESCRIPTION OF THE DRAWINGS

The above and other objects, features and advantages of this invention will become more apparent by reference to the following detailed description of the invention taken in conjunction with the accompanying drawings, wherein:

FIG. 1 is a block diagram that schematically shows the configuration of an optical recording and reproducing apparatus according to a preferred embodiment of the present invention;

FIG. 2 is a schematic diagram that shows the configuration of the optical pickup 20;

FIG. 3 is a simplified plan view that shows the positional relationship of the optical pickup 20 and the spindle motor 12;

FIG. 4 is a simplified perspective view that shows the configuration of the objective-lens driving apparatus 30;

FIG. 5 is simplified perspective view that shows the configuration of the yoke base 41 alone;

FIG. 6 is a simplified perspective view that shows the configuration of the lens holder 42;

FIG. 7 is a side view of the configuration of the objective-lens driving apparatus 30;

FIG. 8 is a simplified cross-sectional view for describing the displacement of the lens holder 42; and

FIG. 9 is a simplified perspective view that shows the configuration of the yoke cover 46 alone.

### DETAILED DESCRIPTION OF THE EMBODIMENTS

Preferred embodiments of the present invention will now be described in detail hereinafter with reference to the accompanying drawings.

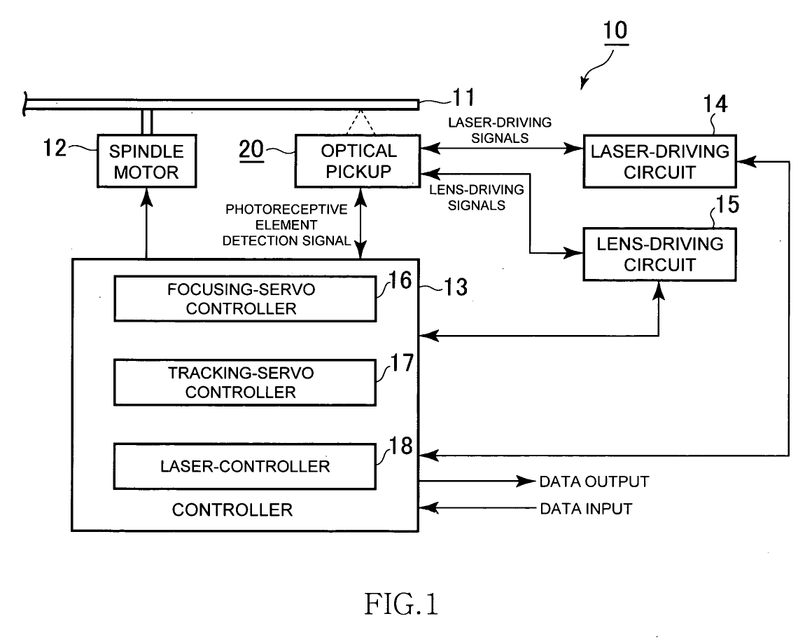

FIG. 1 is a block diagram that schematically shows the configuration of an optical recording and reproducing apparatus according to a preferred embodiment of the present invention.

As shown in FIG. 1, an optical recording and reproducing apparatus 10 comprises a spindle motor 12 for causing an optical disk 11 to rotate; an optical pickup 20 for radiating laser beams onto the optical disk 11 and for receiving light reflected from the optical disk; a controller 13 for controlling the operation of the spindle motor 12 and the optical pickup 20; a laser-driving circuit 14 for supplying laser-driving signals to the optical pickup 20; and a lens-driving circuit 15 for supplying lens-driving signals to the optical pickup 20.

A focusing-servo controller 16, a tracking-servo controller 17, and a laser-controller 18 are included in the controller 13. When the focusing-servo controller 16 is in operation, focus is centered on the information-recording surface of the rotating optical disk 11. When the tracking-servo controller 17 is in operation, the laser-beam spot is automatically tracked relative to the decentered signal track of the optical disk 11. The focusing-servo controller 16 is provided with an auto-gain controlling function in order to automatically adjust the focus gain, and the tracking-servo controller 17 is provided with an auto-gain controlling function in order to automatically adjust the tracking gain. The laser-controller 18 generates the laser-driving signals that are supplied by the laser-driving circuit 14. The laser-controller 18 generates appropriate laser-driving signals on the basis of information concerning the recording condition settings recorded on the optical disk 11.

The focusing-servo controller 16, the tracking-servo controller 17, and the laser-controller 18 need not be built-in circuits within the controller 13 but may also be components separate from the controller 13. These circuits need not be physical circuits but may also be software executed within the controller 13.

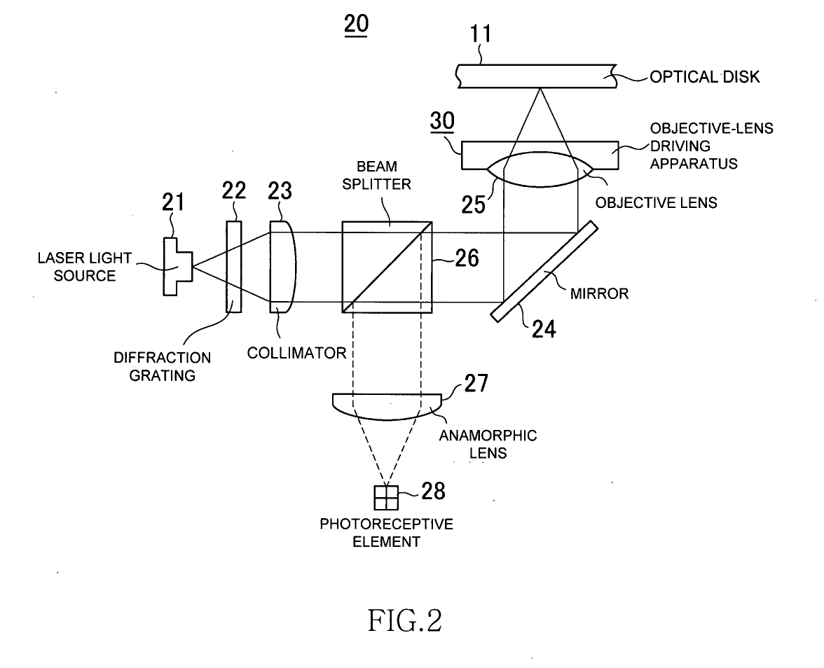

FIG. 2 is a schematic diagram that shows the configuration of the optical pickup 20.

As shown in FIG. 2, the optical pickup 20 comprises a laser light source 21; a diffraction grating 22 for dividing a light beam from the laser light source 21 into a plurality of beams; a collimator 23 for parallelizing the laser beams emitted from the diffraction grating 22; a mirror 24 for guiding the parallelized laser beams toward the optical disk 11; an objective lens 25 for converging the laser beams onto the disk surface; a beam splitter 26 for guiding light reflected from the optical disk 11 toward a photoreceptive element 28; an anamorphic lens 27 for converging the reflected light from the beam splitter 26; and the photoreceptive element 28 for receiving the reflected light that was converged by the anamorphic lens 27. The position of the objective lens 25 relative to the optical disk 11 is precisely controlled by an objective-lens driving apparatus 30. More specifically, focus correction for focusing the beam spot on the recording surface of the optical disk 11 is performed by driving the objective lens 25 in the focusing direction, and tracking correction for causing the beam spot to follow the track of the optical disk 11 is performed by driving the objective lens 25 in the tracking direction. Correction of the tilt angle that corresponds to the curvature of the disk is performed by causing the objective lens 25 to rotate in the tracking direction with the tangential direction as the axis of rotation.

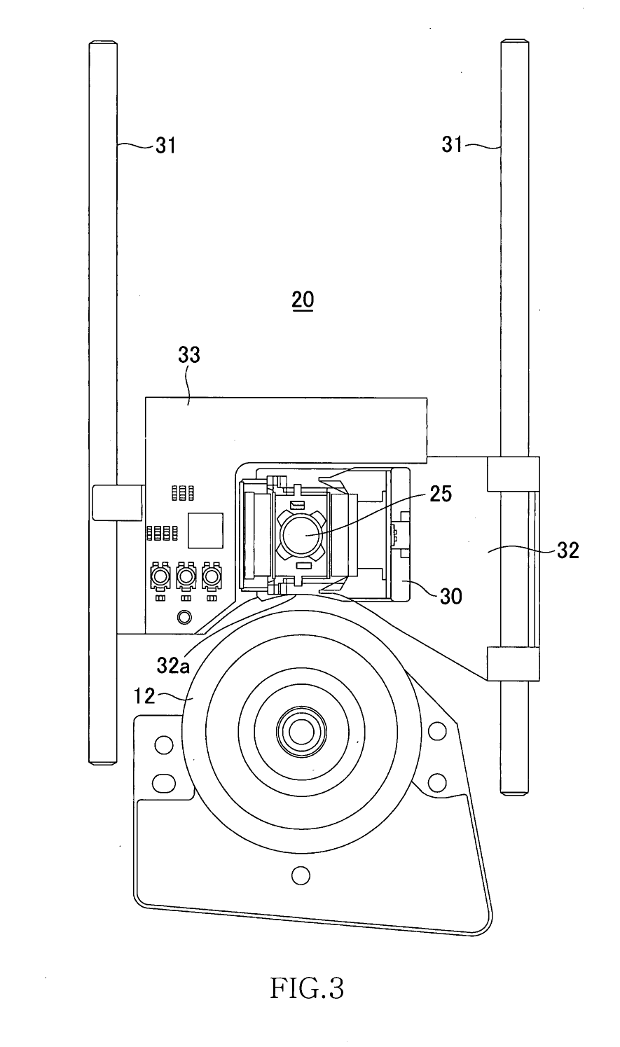

FIG. 3 is a simplified plan view that shows the positional relationship of the optical pickup 20 and the spindle motor 12.

As shown in FIG. 3, the optical pickup 20 is provided with a housing 32 configured to be capable of moving along two guide shafts 31, 31 that are arranged parallel to the radical direction of the optical disk; the objective-lens driving apparatus 30 provided on the housing 32; the objective lens 25 provided within the objective-lens driving apparatus 30; and control substrates 33 including the laser-driving circuit and the like. Though not shown in FIG. 3, optical components such as the laser light source 21 and the beam splitter 26 are also mounted on the housing 32.

One side of the housing 32 on the inner circumferential side in the track direction facing the spindle motor 12 has a curved part 32a that is gently curved to conform to the outer circumferential surface of the spindle motor 12. The optical pickup 20 can be brought toward the inner circumference of the optical disk (not shown). The objective-lens driving apparatus 30 is provided near the curved part 32a, and the surface of the objective-lens driving apparatus 30 facing the spindle motor 12 also has a shape that is curved to conform to the outer circumferential surface of the spindle motor 12. In the resulting design, the objective lens 25 will not contact the spindle motor 12 even when moved to the innermost circumference of the optical disk.

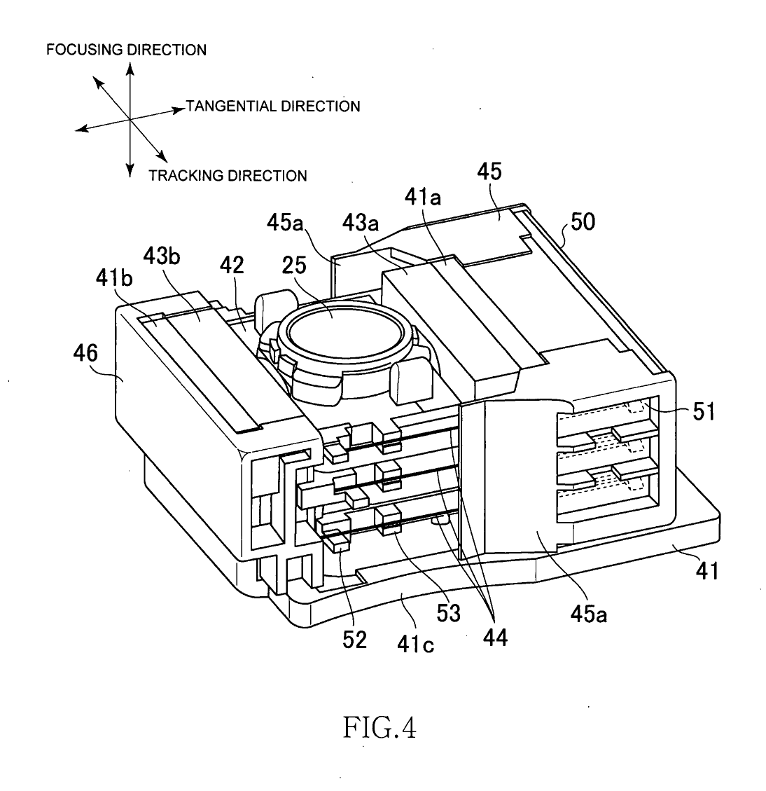

FIG. 4 is a schematic perspective view that shows the configuration of the objective-lens driving apparatus 30.

As shown in FIG. 4, the objective-lens driving apparatus 30 is provided with a yoke base 41 acting as a base member; a lens holder 42 provided on the yoke base 41; the objective lens 25 provided to the center of the upper part of the lens holder 42; permanent magnets 43a, 43b provided to both sides of the lens holder 42 in the tangential direction; wires 44 laid on both sides of the lens holder 42 in the tracking direction; a wire base 45 made of resin and provided in the area near the permanent magnet 43a when viewed from the lens holder 42; and a yoke cover 46 made of resin and provided to the side of the permanent magnet 43b when viewed from the lens holder 42.

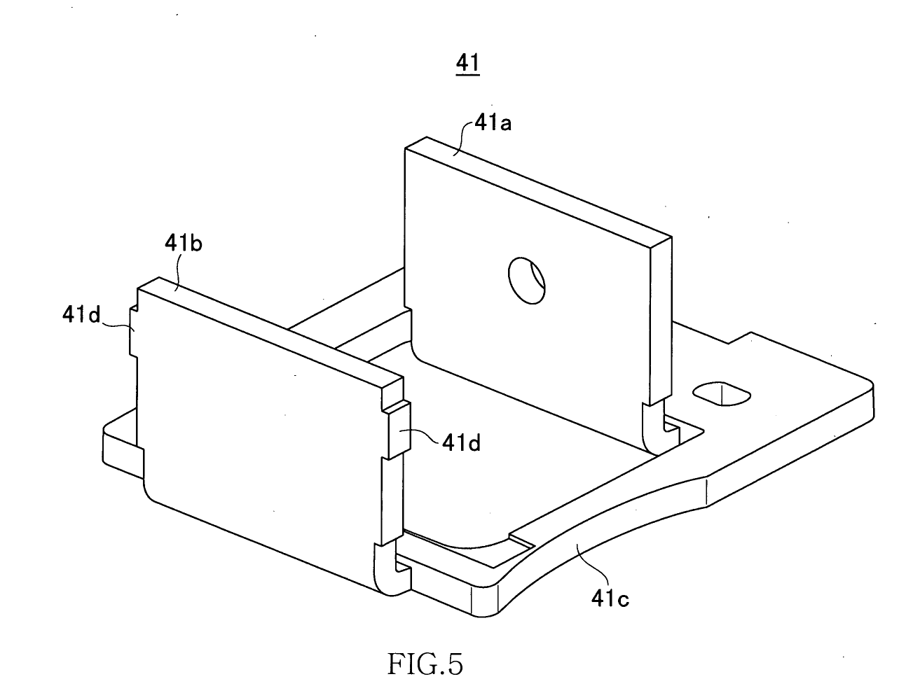

FIG. 5 is schematic perspective view that shows the configuration of the yoke base 41 alone.

As shown in FIG. 5, the yoke base 41 is composed of a magnetic material and has two opposing raised parts 41a, 41b that are formed by a perpendicularly bending part of the yoke base. A curved part 41c that is curved to conform to the outer circumferential surface of the spindle motor 12 is formed on one side of the yoke base 41. A convex part (protuberance) 41d for locking the yoke cover is provided to both the left and right sides of the raised part 41b. The permanent magnets 43a, 43b are attached respectively to the raised parts 41a, 41b of the yoke base 41 having the above configuration and are positioned in the tangential direction of the lens holder 42. The raised parts 41a, 41b of the yoke base 41 thereby function as yokes for the permanent magnets 43a, 43b, and the permanent magnets 43a, 43b are made to generate magnetic fluxes that penetrate substantially in the tangential direction into coils attached to the lens holder 42 and extend in the focusing direction and tracking directions.

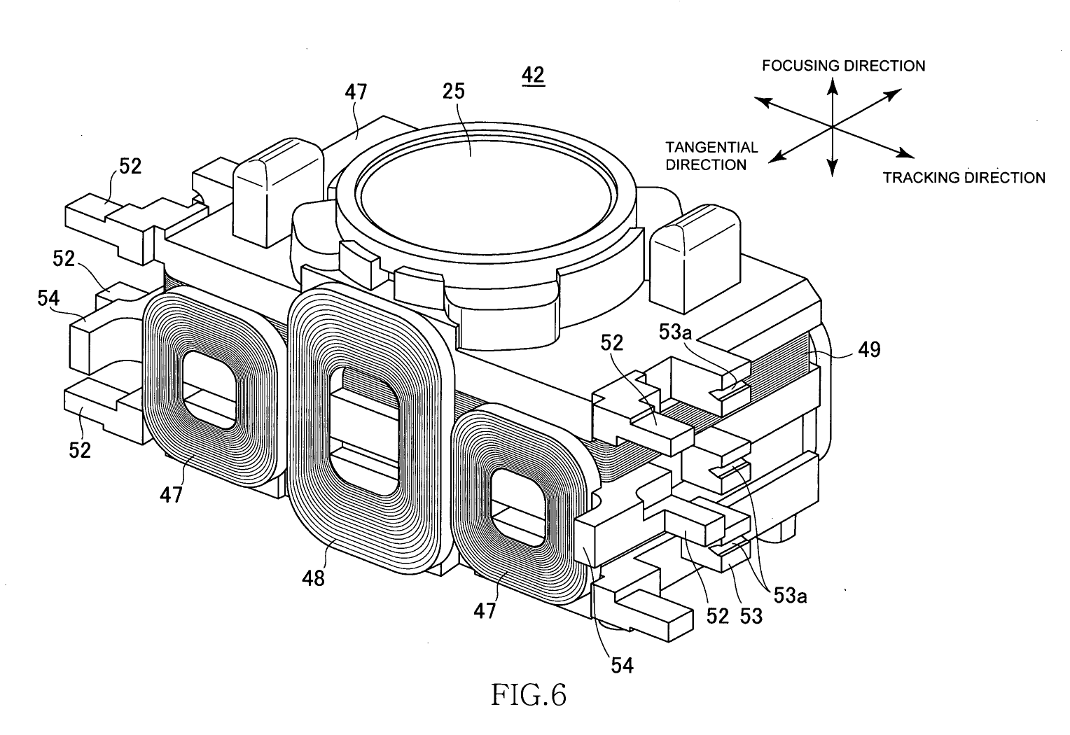

FIG. 6 is a schematic perspective view that shows the configuration of the lens holder 42.

As shown in FIG. 6, the lens holder 42 is substantially block shaped, and comprises a relatively light material having a high bending elasticity, such as a crystal polymer. A circular hole through which laser beams pass is provided to a central part extending from the upper surface of the lens holder 42 to the lower surface, and the objective lens 25 is anchored to the upper part thereof. Tracking coils 48 wrapped around an axis in the tangential direction are provided to the centers of both tangential lateral surfaces of the lens holder 42. Focusing coils 47, 47 wrapped around axes in the tangential direction are provided to both sides of the tracking coils 48. A tilt coil 49 is provided so as to encircle the lateral surfaces of the lens holder 42 with an axis in the focusing direction.

The wires 44 are elastic supporting members for elastically supporting the lens holder 42. The wires also serve for supplying electrical current to the focusing coils 47, the tracking coils 48, and the tilt coil 49. Three wires are connected to each side of the lens holder 42 for a total of six wires.

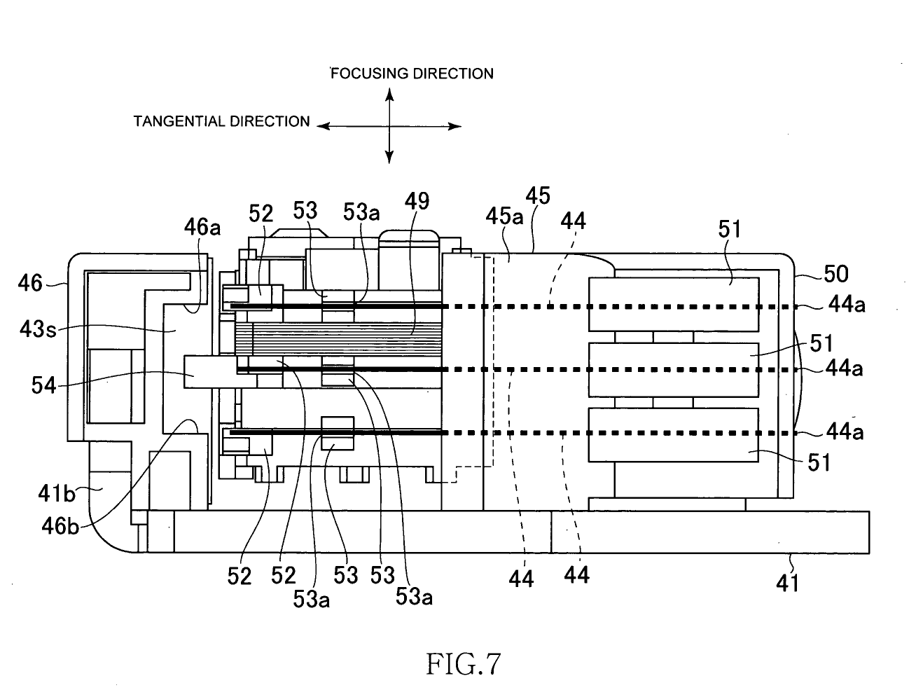

FIG. 7 is a side view of the configuration of the objective-lens driving apparatus 30.

As shown in FIG. 7, ends 44a of the wires 44 are fixed by soldering onto a printed substrate 50 provided to the back surface of the wire base 45. Damping-material accommodation boxes 51 that are filled with a gel-form damping material are provided within a set range on the lateral surfaces of the wire base 45 in which the wires 44 extend from the printed substrate 50 toward the lens holder 42. The wires 44 are provided to pass through these damping-material accommodation boxes 51. The wires 44 are thereby enveloped by damping material, and vibration of the wires 44 is absorbed by the damping material.

The other ends 44b of the wires 44 are fixed by soldering to protrusions 52 for wrapping the terminals of the driving coils 47 through 49 and are electrically connected to the terminals of the driving coils 47 through 49. Positioning protrusions 53 are provided to the lateral surfaces of the lens holder 42. The middle regions of the wires 44 are fit into V-grooves 53a provided to the distal-end parts of the positioning protrusions 53. The lens holder 42 is thus elastically supported by the wires 44, and the yoke base 41 is held in a floating state.

The wire base 45 shown in FIG. 4 is not only serves as a fixation member for fixing the ends of the wires 44 but also a protecting member of the wires 44. The lateral surface portions of the wire base 45 have a shape extending in the wiring direction of the wires 44, and the wire base 45 therefore has wire cover parts 45a extending in the tangential direction for partially covering the wires. The wires 44 can be reliably protected when the entire apparatus is covered using a cover, as in the prior art, but the wires are exposed when the cover is omitted in order to reduce the size of the apparatus, and wire deformation, reduction of the damping material, and other defects may occur. However, providing the wire cover parts 45a to the wire base 45 and providing a structure for protecting the wires to the wire base 45 itself, as in the present embodiment, allows reductions in the size of the apparatus to be achieved without producing the aforementioned defects. The wire cover parts 45a need not cover the entire length of the wires extending in the tangential direction but may partially cover the wires. In other words, the wire cover parts 45a should cover a region so that no contact is made during handling with the portions that serves as elastic members of the wires. By protecting the smallest range necessary, the size of the objective-lens driving apparatus can be reduced, and the objective-lens driving apparatus can be easily handled during attachment to the optical pickup.

The wire cover parts 45a of the present embodiment have a tapered shape that grows thinner approaching the other ends of the wires. The length of the wire cover parts 45a can thereby be increased relative to other motors having the same diameter, and safety is increased. However, as described above, the wire cover parts 45a need not protect the entirety of the wires.

The wire base 45 also serves to protect the upper surfaces of the permanent magnet 43a and the raised part 41a on one side of the yoke base 41. The upper surface of the wire base 45 is therefore set to be higher than the upper surfaces of the permanent magnet 43a and the raised part 41a of the yoke base, and the corner parts of the wire base 45 are chamfered into a rounded shape. When the entire apparatus is covered by a resin cover as in the prior art, even if the objective-lens driving apparatus collides with the optical disk, the cover that covers the entire apparatus collides with the optical disk and the disk surface will not suffer excessive damaged, but when the cover is omitted in order to reduce the size of the apparatus, the metal portions, i.e., the permanent magnet 43a and the raised part 41a of the yoke base 41, are exposed, and therefore the disk surface may be damaged. However, contact between the metal portions and the disk surface can be prevented by making the wire base 45 higher than the upper surfaces of the permanent magnet 43a and the raised part 41a of the yoke base 41, as in the present embodiment.

The yoke cover 46 of the present embodiment serves to protect the upper surfaces of the permanent magnet 43b and the raised part 41b on the other side of the yoke base 41, in similar fashion to the wire base 45, and partially covers the corner parts of the permanent magnet 43b and the raised part 41b. The upper surface of the yoke cover 46 is higher than the upper surfaces of the permanent magnet 43b and the raised part 41b of the yoke base 41, and the corner parts of the yoke cover 46 are chamfered into a rounded shape. When the entire apparatus is covered by a resin cover as in the prior art, even if the objective-lens driving apparatus collides with the optical disk, the cover that covers the entire apparatus collides with the optical disk and the disk surface will not be damaged, but when the cover is omitted in order to reduce the size of the apparatus, the metal portions, i.e., the permanent magnet 43b and the raised part 41b of the yoke base 41, are exposed, and therefore the disk surface may be excessively damaged.

The existing wire base 45 may be used as described above for the permanent magnet 43a and the raised part 41a on the one side, but an existing member that can be used for the permanent magnet 43b and the raised part 41b on the other side is not present. The yoke cover 46 is therefore also provided for covering only the permanent magnet 43b and the raised part 41b, and the height of the yoke cover 46 is made to be higher than the upper surfaces of the permanent magnet 43b and the raised part 41b of the yoke base, as in the present embodiment, whereby such problems can be resolved.

The yoke cover 46 of the present embodiment serves not only as a cover, as described above, but also as a stopper for limiting the range of movement of the lens holder 42.

As shown in FIG. 7, a stopper part 54 that extends toward the yoke cover 46 in the wiring direction of the wires 44 is provided to the lateral surface of the lens holder 42. The stopper part 54 of the present embodiment is integrally formed with the middle protrusion 52 for terminal wrapping. Meanwhile, an upper locking strip 46a and a lower locking strip 46b are provided to the lateral surface of the yoke cover 46. The stopper part 54 is positioned between the upper locking strip 46a and the lower locking strip 46b. When the lens holder 42 is displaced by a large amount in the focusing direction, the stopper part 54 contacts the upper locking strip 46a or the lower locking strip 46b, and displacement in the focusing direction can therefore be limited. When the lens holder 42 is displaced by a large amount in the tracking direction, the stopper part 54 contacts the lateral surface of a permanent magnet, and displacement in the tracking direction can therefore be limited. The amount of displacement of the tilt angle can also be limited due to contact of the stopper part 54 with the upper locking strip 46a, the lower locking strip 46b, or the lateral surface of a permanent magnet. Collisions between the coils and the permanent magnets can therefore be prevented.

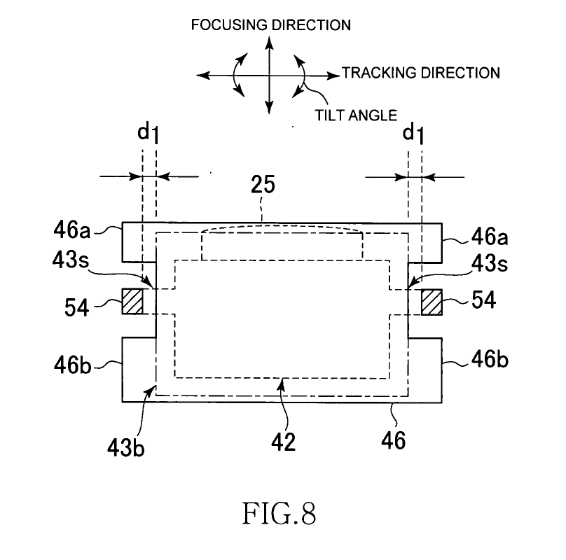

FIG. 8 is a schematic cross-sectional view for describing the displacement of the lens holder 42.

As shown in FIG. 8, the stopper part 54 is provided to be separated from the lateral surface of the permanent magnet 43b by a prescribed distance d1. The lens holder 42 and the objective lens 25 are shown by the broken lines, and the permanent magnet 43b is shown by the square-shaped alternatingly dotted line. When the lens holder 42 is displaced by a large amount in the focusing direction shown by the arrow, the stopper part 54 contacts the upper locking strip 46a or the lower locking strip 46b, and displacement in the focusing direction can therefore be limited. When the lens holder 42 is displaced by a large amount in the tracking direction shown by the arrow, the stopper part 54 contacts the lateral surface 43s of the permanent magnet 43b, and displacement in the tracking direction can therefore be limited. The displacement of the tilt angle can also be limited due to contact of the stopper part 54 with the upper locking strip 46a, the lower locking strip 46b, or the lateral surface 43s of the permanent magnet 43b.

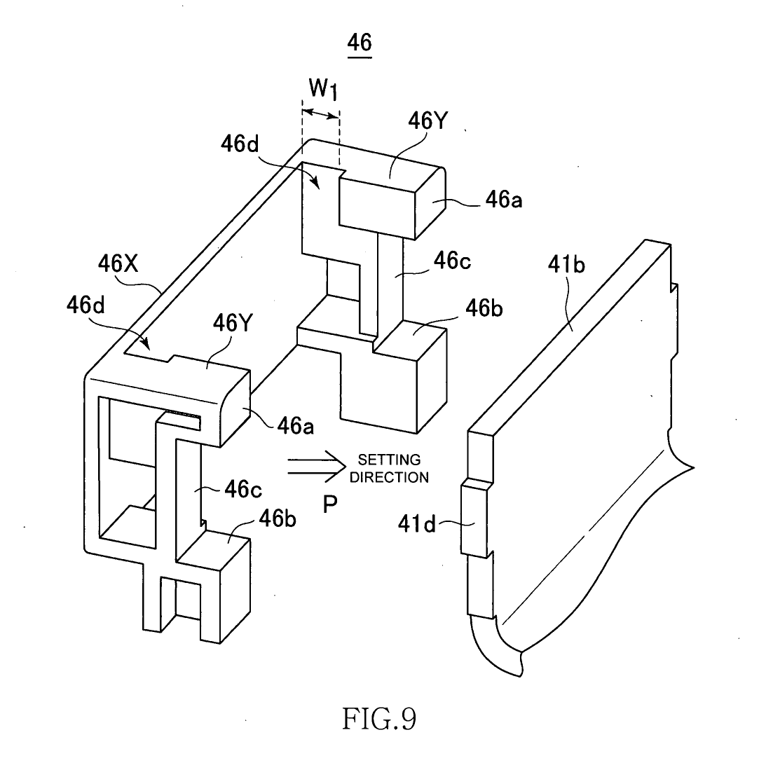

FIG. 9 is a schematic perspective view that shows the configuration of the yoke cover 46 alone.

As shown in FIG. 9, the yoke cover 46 is provided with a back plate part 46X for covering the main surfaces of the raised parts of the yoke base; and lateral surface parts 46Y, 46Y for covering the lateral surfaces of the raised parts. The upper locking strip 46a and the lower locking strip 46b are provided to the lateral surface parts 46Y. The space between the upper locking strip 46a and the lower locking strip 46b is formed as a socket for the convex part (protuberance) 41d (see FIG. 5) provided to the raised part 41b. The space between the back plate part 46X and the upper locking strip 46a has a width W1 that is substantially the same as the thickness of the raised part 41b. A gap part 46d in which the yoke cover 46 can be fit is formed in this space. The yoke cover 46 is set on the raised part 41b from the tangential direction, as shown by the arrow P, and the convex part (protuberance) 41d provided to the raised part 41b is inserted from the socket of the yoke cover 46. The yoke cover 46 is then pressed downward, and the protuberance 41d is fit into the gap part 46d, whereby the yoke cover 46 is attached to the raised part 41b, and the permanent magnet 43b and the raised part 41b of the yoke base are protected by the yoke cover 46. The yoke cover is thus temporarily fixed to the yoke base in a reliable manner using a simple configuration according to the yoke cover 46 of the present embodiment, and bonding and other operations are therefore easily performed.

According to the objective-lens driving apparatus 30 of the present embodiment as described above, the wire base 45 itself provides a protective structure for covering a part of the wiring region, and therefore a specialized cover can be omitted, the overall size of the apparatus can be reduced, workers will not touch the wires or the damping material during attachment to the optical pickup or other procedures, and the objective-lens driving apparatus can be handled in a more straightforward manner. According to the objective-lens driving apparatus 30 of the present embodiment, the wire cover parts 45a have a tapered shape that grows progressively thinner toward the other end of the wires, and therefore the ends of the wire cover parts 45a do not protrude beyond the curved part of the yoke base, and the wire cover parts 45a can be housed further to the inside than the yoke base. Therefore, the permitted range of motion of the lens holder is not limited, and the objective-lens driving apparatus can be moved to the innermost circumference of the optical disk even if the space occupied by the spindle motor in the radial direction is enlarged.

According to the objective-lens driving apparatus 30 of the present embodiment, instead of covering the entirety of the objective-lens driving apparatus using a cover, only the necessary portions; i.e., the permanent magnet 43b and the raised part 41b of the yoke base, are covered. Defects due to the absence of the cover can accordingly be avoided, and reductions in the overall size of the apparatus can be achieved. In other words, even if the objective-lens driving apparatus collides with the optical disk, the yoke cover 46 and not the metal portions; i.e., the permanent magnet 43b and the raised part 41b of the yoke base, will collide with the optical disk, and therefore the impact on the disk surface can be largely alleviated.

Since the yoke cover 46 doubles as means for limiting the movable range of the objective lens 25, such means need not be provided separately, and a high-performance objective-lens driving apparatus having a small size can be implemented. The yoke cover 46 is also provided with the gap part 46d, which has a width equal to the thickness of the raised part, and has a structure in which the raised part 41b is fit into the yoke cover 46. The yoke cover 46 is capable of attaching to and detaching from the raised part 41b of the yoke base, and therefore the yoke cover 46, can be reliably attached to the raised part 41b of the yoke base using a simple structure. In particular, yoke cover is temporarily fixed to the yoke base in a reliable manner, and therefore bonding and other operations are easily performed.

The present invention has thus been shown and described with reference to specific embodiments. However, it should be noted that the present invention is in no way limited to the details of the described arrangements but changes and modifications may be made without departing from the scope of the appended claims.

For example, an example was given in the embodiment above of an objective-lens driving apparatus in which three types of driving coils, i.e., focusing coils, tracking coils, and a tilt coil, were provided as driving coils, and in which three wires were provided to both the left and right for a total of six wires. However, the number of driving coils and the number of wires of the present invention are not particularly limited. Therefore, the tilt coil may be omitted, and two wires may be provided to both the left and right for a total of four wires, for example.

Wires were used as supporting members for elastically supporting the lens holder 42 in the embodiment above, but elongated plate springs may also be used as the supporting members of the lens holder 42.

An example was given in the embodiment above in which a yoke cover was provided in a case in which the wire base 45 itself provided a protective structure for the wires, but the present invention is not limited to such cases. For example, the yoke cover may also be provided in configurations in which a separate cover is placed on a wire base 45 that does not have a structure for protecting the wires, and in which the yoke, permanent magnets, and wires are protected.

What is claimed is:

1. An objective-lens driving apparatus, comprising:
a lens holder for holding an objective lens;
a driving coil attached to the lens holder;
a permanent magnet for producing a magnetic flux in the driving coil;
a base member to which the permanent magnet is attached;
a supporting member for elastically supporting the lens holder;
a fixation member to which an end of the supporting member is fixed; and
a yoke cover made of a resin and attached to the raised part of the base member, wherein
an upper surface of the yoke cover is higher than the upper surface of the permanent magnet and the raised part of the base member.

2. The objective-lens driving apparatus as claimed in claim 1, further comprising:
a stopper part, which is provided to one of the lens holder and the yoke cover, is extended toward the other of the lens holder and the yoke cover, and is made to limit movable range of the lens holder in a tracking direction; and
a locking strip, which is provided to the other of the lens holder and the base member and that is made to limit at least movable range of the stopper part in a focusing direction.

3. The objective-lens driving apparatus as claimed in claim 2, wherein the yoke cover comprises a structure capable of being attached and detached from the raised part of the base member.

4. The objective-lens driving apparatus as claimed in claim 3, wherein the yoke cover comprises a gap part having a width equal to a thickness of the raised part of the base member; and a structure in which the raised part is fit into the gap part.

5. An optical pickup, comprising:
a laser light source;
an objective lens for focusing a laser beam emitted from the laser light source onto a recording surface of an optical disk;
a light detector for receiving light reflected from the optical disk; and
an objective-lens driving apparatus for driving the objective lens, wherein
the objective-lens driving apparatus comprises:
a lens holder for holding the objective lens;
a driving coil attached to the lens holder;
a permanent magnet for producing a magnetic flux in the driving coil;
a base member to which the permanent magnet is attached;
a supporting member for elastically supporting the lens holder;
a fixation member to which an end of the supporting member is fixed; and
a yoke cover made of a resin and attached to the raised part of the base member, wherein
an upper surface of the yoke cover is higher than the upper surface of the permanent magnet and the raised part of the base member.

6. An optical recording and reproducing apparatus, comprising:
a spindle mechanism for causing an optical disk to rotate;
an optical pickup provided to be capable of moving in a radial direction of the optical disk; and
a controller for controlling the optical pickup, wherein
the optical pickup comprises:
a laser light source;
an objective lens for focusing a laser beam emitted from the laser light source onto a recording surface of an optical disk;
a light detector for receiving light reflected from the optical disk; and
an objective-lens driving apparatus for driving the objective lens, wherein
the objective-lens driving apparatus comprises:
a lens holder for holding the objective lens;
a driving coil attached to the lens holder;
a permanent magnet for producing a magnetic flux in the driving coil;
a base member to which the permanent magnet is attached;
a supporting member for elastically supporting the lens holder;
a fixation member to which an end of the supporting member is fixed; and
a yoke cover made of a resin and attached to the raised part of the base member, wherein
an upper surface of the yoke cover is higher than the upper surface of the permanent magnet and the raised part of the base member.
